(19) United States
(12) Patent Application Publication
(10) Pub. No.: US 2026/0247465 A1
(43) Pub. Date: Aug. 20, 2026

(54) ELECTRONIC DEVICE FOR WIRELESS LAN COMMUNICATION, AND OPERATION METHOD THEREFOR

(71) Applicant: Samsung Electronics Co., Ltd., Suwon-si (KR)

(72) Inventors: Jusik YUN, Suwon-si (KR); Hyunkee MIN, Suwon-si (KR); Wonbin PARK, Suwon-si (KR); Changmok YANG, Suwon-si (KR); Junsu CHOI, Suwon-si (KR); Hyeonu CHOI, Suwon-si (KR)

(21) Appl. No.: 19/639,678

(22) Filed: Apr. 6, 2026

Related U.S. Application Data
(63) Continuation of application No. PCT/KR2024/014205, filed on Sep. 20, 2024.

(30) Foreign Application Priority Data
Oct. 11, 2023 (KR) 10-2023-0135337
Nov. 15, 2023 (KR) 10-2023-0158230

(51) Int. Cl. H04W 76/15; H04W 52/34; H04W 84/12

(52) U.S. Cl. CPC H04W 76/15; H04W 52/34; H04W 84/12

(57) ABSTRACT

An electronic device includes: a communication circuit configured to send and receive a signal via wireless LAN communication; memory, comprising one or more storage media, storing one or more computer programs; and one or more processors communicatively coupled to the communication circuit and the memory. The one or more computer programs include computer-executable instructions that, when executed by the one or more processors individually or collectively, cause the electronic device to: establish multiple links with an external electronic device through the communication circuit, identify a wireless LAN communication-related reliability of each of the multiple links while performing wireless LAN communication through the multiple links, and when at least one link of the multiple links does not satisfy a designated reliability condition, based on the wireless LAN communication-related reliability of each of the multiple links, perform wireless LAN communication with the external electronic device through another link of the multiple links.

### CROSS-REFERENCE TO RELATED APPLICATION(S)

This application is a continuation application, claiming priority under 35 U.S.C. § 365(c), of an International application No. PCT/KR2024/014205, filed on Sep. 20, 2024, which is based on and claims the benefit of a Korean patent application number 10-2023-0135337, filed on Oct. 11, 2023, in the Ministry of Intellectual Property (MOIP), and of a Korean patent application number 10-2023-0158230, filed on Nov. 15, 2023, in the Ministry of Intellectual Property (MOIP), the disclosure of each of which is incorporated by reference herein in its entirety.

### BACKGROUND

### 1. Field

The disclosure relates to an electronic device for wireless local area network (LAN) communication and an operation method therefor.

### 2. Description of Related Art

A wireless local area network (WLAN) system may support a wireless connection between various electronic devices, such as a smartphone, tablet personal computer, or laptop by using a designated frequency band (e.g., about 2.4 GHz band, about 5 GHz band, and/or about 6 GHz band).

The WLAN system may be installed in private spaces, such as homes, as well as in public spaces, such as airports, train stations, offices, or department stores. The WLAN system may be defined in the institute of electrical and electronics engineers (IEEE) 802.11 standard. For example, IEEE 802.11 standards are constantly evolving, such as IEEE 802.11b, IEEE 802.11a, IEEE 802.11g, IEEE 802.11n, IEEE 802.11ac, IEEE 802.11ax, and IEEE 802.11be.

The above information is presented as background information only to assist with an understanding of the disclosure. No determination has been made, and no assertion is made, as to whether any of the above might be applicable as prior art with regard to the disclosure.

### SUMMARY

A wireless LAN system (e.g., Wi-Fi 8) may require a high transmission reliability (e.g., ultra-high reliability (UHR)) (or transmission success rate) of a designated target success rate (e.g., 99.99%) or higher in order to support services that use various senses (e.g., visual, tactile, and/or auditory) such as a metaverse, a virtual reality, or a mixed reality. In a wireless LAN system, it may be important to secure a relatively high signal to noise ratio (SNR) in order to achieve relatively high transmission reliability. A relatively high SNR may be secured by a relatively high transmission power.

An electronic device may have transmission power (or radio wave emission amount) limited based on a specific absorption rate (SAR). The transmission power of wireless LAN communication limited by the specific absorption rate may be divided into multiple links when multi-link operation (MLO) is used in the electronic device. The electronic device may have transmission reliability reduced for each link due to the lowered transmission power resulting from being divided into multiple links.

Aspect of the disclosure are to address at least the above-mentioned problems and/or disadvantages and to provide at least the advantages described below. Accordingly, an aspect of the disclosure is to provide a device and method for ensuring reliability for wireless LAN communication in an electronic device.

Additional aspects will be set forth in part in the description which follows and, in part, will be apparent from the description, or may be learned by practice of the presented embodiments.

In accordance with an aspect of the disclosure, an electronic device is provided. The electronic device includes: a communication circuit configured to send and receive a signal via wireless local area network (LAN) communication; memory, comprising one or more storage media, storing one or more computer programs; and one or more processors communicatively coupled to the communication circuit and the memory. The one or more computer programs include computer-executable instructions that, when executed by the one or more processors individually or collectively, cause the electronic device to: establish multiple links with an external electronic device through the communication circuit, identify a wireless LAN communication-related reliability of each of the multiple links while performing wireless LAN communication through the multiple links, and when at least one link of the multiple links does not satisfy a designated reliability condition, based on the wireless LAN communication-related reliability of each of the multiple links, perform wireless LAN communication with the external electronic device through another link of the multiple links.

In accordance with another aspect of the disclosure, an operation method for the electronic device is provided. The method includes: establishing, by the electronic device, multiple links for wireless local area network (LAN) communication with an external electronic device; identifying, by the electronic device a wireless LAN communication-related reliability of each of the multiple links while performing wireless LAN communications through the multiple links; and when at least one link of the multiple links does not satisfy a designated reliability condition, based on the wireless LAN communication-related reliability of each of the multiple links, performing, by the electronic device, wireless LAN communication with the external electronic device through another link of the multiple links.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include: establishing, by the electronic device, multiple links for wireless local area network (LAN) communication with an external electronic device; identifying, by the electronic device a wireless LAN communication-related reliability of each of the multiple links while performing wireless LAN communications through the multiple links; and when at least one link of the multiple links does not satisfy a designated reliability condition, based on the wireless LAN communication-related reliability of each of the multiple links, performing, by the electronic device, wireless LAN communication with the external electronic device through another link of the multiple links.

According to an embodiment of the disclosure, the electronic device performs wireless LAN communication through a single link, based on the reliability (or transmission reliability) of multiple links with an external electronic device (e.g., an access point (AP)), thereby improving the reliability for wireless LAN communication.

According to an embodiment, the electronic device adaptively reallocates the transmission power assigned to multiple links with an external electronic device (e.g., access point (AP)), thereby improving the reliability for wireless LAN communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block view illustrating an electronic device in a network environment according to an embodiment of the disclosure;

FIG. 2 is an example of multi-link operation (MLO) in a wireless LAN system according to an embodiment of the disclosure;

FIG. 3 is a block view illustrating an electronic device supporting wireless LAN communication according to an embodiment of the disclosure;

FIG. 4 is a flowchart illustrating switching a wireless LAN communication operation mode, based on a reliability of each link, in an electronic device according to an embodiment of the disclosure;

FIG. 5 is a flowchart illustrating switching a wireless LAN communication operation mode, based on a reliability of multiple links, in an electronic device according to an embodiment of the disclosure;

FIG. 6 is an example of a reliability based on a wireless LAN communication operation mode in an electronic device according to an embodiment of the disclosure;

FIG. 7 is a flowchart illustrating reallocating transmission power of multiple links in an electronic device according to an embodiment of the disclosure; and

FIG. 8 is an example of reallocating transmission power of multiple links in an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

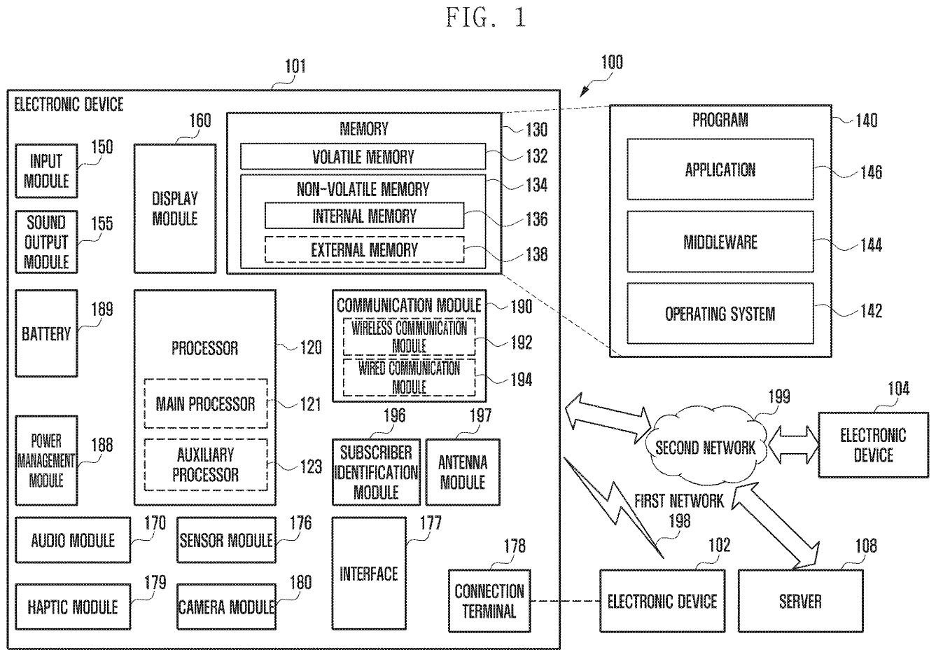

FIG. 1 is a block diagram illustrating an example electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to one embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form high frequency (e.g., a mmWave) antenna module. According to an embodiment, the high frequency (e.g., the mmWave) antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas. For example, the plural antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

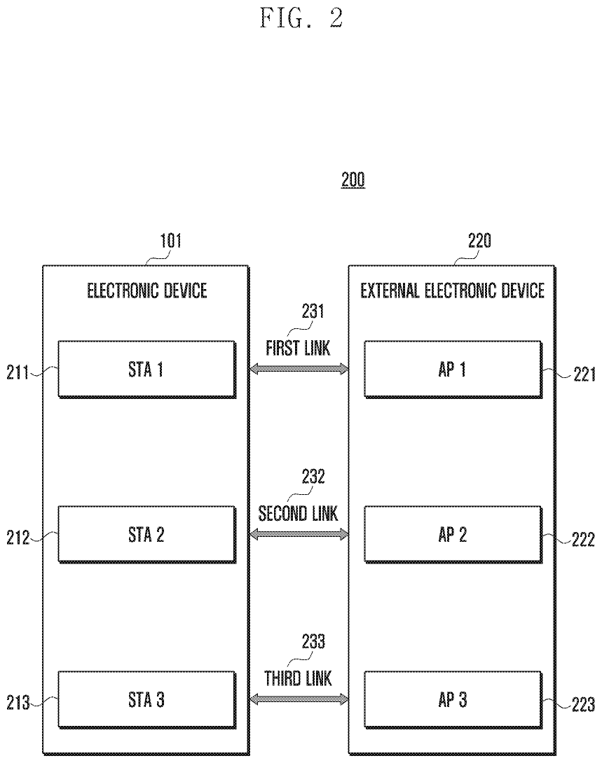

FIG. 2 is an example of multi-link operation (MLO) in a wireless LAN system according to an embodiment of the disclosure. For example, the electronic device 101 in FIG. 2 may be at least partially similar to the electronic device 101 in FIG. 1, or may further include other embodiments of the electronic device.

Referring to FIG. 2, a wireless LAN system 200 may include at least one of the electronic device 101 or an external electronic device 220 (e.g., the electronic device 102 in FIG. 1). The electronic device 101 may perform wireless LAN communication with an external electronic device 220. For example, wireless LAN communication may be a communication method defined in the IEEE 802.11 standard and may include Wi-Fi. For example, the external electronic device 220 may perform the role of a base station that provides wireless LAN communication to at least one electronic device 101 located within a communication radius of the wireless LAN system 200. For example, the external electronic device 220 may include an access point (AP) according to the IEEE 802.11 standard. For example, the electronic device 101 may include a station (STA) according to the IEEE 802.11 standard.

According to an embodiment, the electronic device 101 and the external electronic device 220 may support multi-link operation (MLO). MLO may include a communication method of transmitting and/or receiving data (or a packet) through multiple links (e.g., a first link 231, a second link 232, and/or a third link 233). For example, in the case of supporting MLO, the external electronic device 220 may include multiple APs (e.g., AP 1 221, AP 2 222, and/or AP 3 223) corresponding to multiple links (e.g., a first link 231, a second link 232, and/or a third link 233) with the electronic device 101. For example, in the case of supporting MLO, the electronic device 101 may include multiple STAs (e.g., STA 1 211, STA 2 212, and/or STA 3 213) corresponding to multiple links (e.g., the first link 231, the second link 232, and/or the third link 233) with the external electronic device 220. For example, the multiple links (e.g., the first link 231, the second link 232, and/or the third link 233) for MLO may include different media access control (MAC) addresses. For example, the multiple STAs (e.g., STA 1 211, STA 2 212, and/or STA 3 213) included in the electronic device 101 may include different MAC addresses. For example, the electronic device 101 and the external electronic device 220 may perform wireless LAN communication by using one Internet protocol (IP) address.

According to an embodiment, in the case of supporting MLO, the electronic device 101 may perform wireless LAN communication with the external electronic device 220 through each of the links (e.g., the first link 231, the second link 232, and/or the third link 233). For example, the electronic device 101 (e.g., STA 1 211) may transmit and/or receive data (or packets) to and/or from the external electronic device 220 (e.g., AP 1 221) through the first link 231. For example, data may be transmitted and/or received through a frequency band or a channel corresponding to the first link 231. For example, the electronic device 101 (e.g., STA 2 212) may transmit and/or receive data to and/or from the external electronic device 220 (e.g., AP 2 222) through the second link 232. For example, data may be transmitted and/or received through a frequency band or a channel corresponding to the second link 232. For example, the electronic device 101 (e.g., STA 3 213) may transmit and/or receive data to and/or from the external electronic device 220 (e.g., AP 3 223) through the third link 233. For example, data may be transmitted and/or received through a frequency band or a channel corresponding to the third link 233.

According to an embodiment, in the case of supporting MLO, the external electronic device 220 may perform wireless LAN communication with the electronic device 101 through each of the links (e.g., the first link 231, the second link 232, and/or the third link 233). For example, the external electronic device 220 (e.g., AP 1 221) may transmit and/or receive data (or packets) to and/or from the electronic device 101 through the first link 231. For example, the external electronic device 220 (e.g., AP 2 222) may transmit and/or receive data to and/or from the electronic device 101 through the second link 232. For example, the external electronic device 220 (e.g., AP 3 223) may transmit and/or receive data to and/or from the electronic device 101 through the third link 233.

According to an embodiment, frequency bands (or channels) of the first link 231, the second link 232, and the third link 233 may be configured to be different from each other. For example, the first link 231 may support a first frequency band (e.g., a 2.4 GHz band), the second link 232 may support a second frequency band (e.g., a 5 GHz band), and the third link 233 may support a third frequency band (e.g., a 6 GHz band).

According to an embodiment, the first link 231, the second link 232, and/or the third link 233 may also be used by other external electronic devices other than the electronic device 101 and the external electronic device 220. For example, the electronic device 101 may support a carrier sense multiple access with collision avoidance (CSMA/CA) scheme so that the electronic device 101 and other external electronic devices may use the same link simultaneously without influencing each other. For example, in the case of supporting CSMA/CA, the electronic device 101 may identify whether other external electronic devices are transmitting data through a specific link (e.g., the first link 231, the second link 232, and/or the third link 233). The electronic device 101 may limit the transmission of data through a specific link when it is determined that another external electronic device transmits data through the specific link. For example, in the case of determining that another external electronic device does not transmit data through a specific link, the electronic device 101 may transmit data through the specific link according to a designated method. For example, the specified method may include a clear channel assessment (CCA). For example, the first link 231, the second link 232, and/or the third link 233 may independently support CSMA/CA.

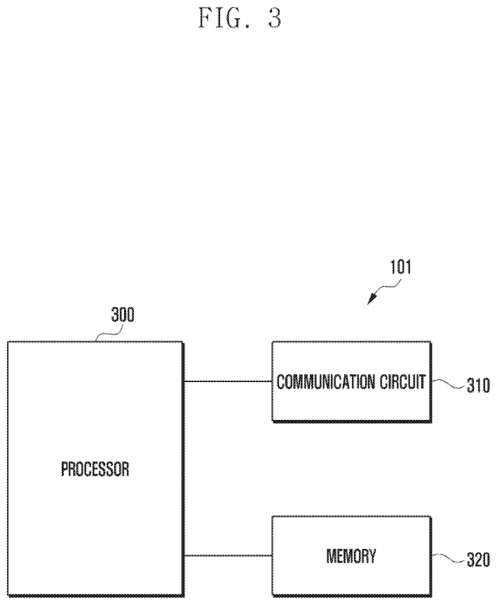

FIG. 3 is a block view illustrating an electronic device supporting wireless LAN communication according to an embodiment of the disclosure. For example, the electronic device 101 in FIG. 3 may be at least partially similar to the electronic device 101 in FIG. 1 or 2, or may further include other embodiments of the electronic device.

Referring to FIG. 3, the electronic device 101 may include at least one of a processor 300, a communication circuit (or communication circuitry) 310, and memory 320. For example, the processor 300 may be substantially identical to the processor 120 in FIG. 1 or included in the processor 120. The communication circuit 310 may be substantially identical to the wireless communication circuit 192 in FIG. 1 or included in the wireless communication circuit 192. The memory 320 may be substantially identical to the memory 130 in FIG. 1 or included in the memory 130. By way of example, the processor 300 may include at least one of an application processor or a communication processor. For example, the processor 300 may be operatively, functionally, and/or electrically connected to at least one of the communication circuit 310 or the memory 320. For example, the processor 300 may include at least one processor including processing circuitry.

According to an embodiment, the processor 300 may control the communication circuit 310 to establish multiple links (e.g., the first link 231, the second link 232, and/or the third link 233 in FIG. 2) with an external electronic device (e.g., the external electronic device 220 in FIG. 2). For example, the processor 300 may control, through at least one link, the communication circuit 310 to establish multiple links with the external electronic device 220. For example, the processor 300 may acquire information related to MLO of the external electronic device 220 from a beacon or a probe response frame received from the external electronic device 220 through the first frequency band (or the first link 231). The processor 300 may control the communication circuit 310 to transmit an association request frame associated with the multiple links to the external electronic device 220 through at least one link, based on information associated with MLO of the external electronic device 220. For example, in case that information associated with an acceptance is acquired from the external electronic device 220 in response to the association request frame, the processor 300 may determine that multiple links with the external electronic device 220 have been established. For example, in case that information associated with a rejection related to at least one of the multiple links is acquired from the external electronic device 220 in response to the association request frame, the processor 300 may determine that the establishment of at least one link with the external electronic device 220, which corresponds to the rejection-related information among the multiple links, has failed. For example, the at least one link corresponding to the rejection-related information may be excluded from a link establishment with the external electronic device 220. By way of example, the association request frame corresponds to information related to the establishment of the first link 231, the second link 232, and/or the third link 233, and may include information related to the function (capability) and/or operational parameter of each link. For example, the information associated with MLO may include not only information associated with the first frequency band (or the first link 231) through which a beacon or a probe response frame has been received, but also information associated with the second frequency band (or the second link 232) and/or the third frequency band (or the third link 233) which are supportable by the external electronic device 220 for MLO. For example, information associated with a frequency band (or link) may include a basic service set identifier (BSSID) and/or a variable associated with MLO for each frequency band (or link).

According to an embodiment, the processor 300 may control the communication circuit 310 to control transmission power associated with wireless LAN communication of multiple links (e.g., the first link 231, the second link 232, and/or the third link 233) with the external electronic device 220. For example, the processor 300 may identify transmission power (e.g., P_{budget} in Equation 1) available for data transmission through wireless LAN communication at a current time point, based on a specific absorption rate (SAR). For example, the transmission power for wireless LAN communication may be identified in the case where data to be transmitted by the electronic device 101 through the wireless LAN communication exists or in the case where the processor 300 acquires state information of each of the multiple links from the communication circuit 310. For example, the transmission power for WLAN communication may be identified based on Equation 1 when a time average SAR (TAS) method is used.

$${P}_{budget} = {P}_{lim} \times {T}_{win} - {P}_{agg} \qquad Equation 1$$

Here, P_{budget} may represent the transmission power available for wireless LAN communication configured based on the current SAR, Pₗᵢₘ may represent the maximum transmission power allowed for wireless LAN communication configured based on the SAR, T_{win} may represent the time interval configured to calculate the average transmission power in the TAS method, and P_{agg} may represent the accumulated value of the transmission power used for wireless LAN communication before the current time within T_{win}.

For example, the processor 300 may divide and allocate transmission power (e.g., P_{budget} in Equation 1) available for data transmission through wireless LAN communication to multiple links (e.g., the first link 231, the second link 232, and/or the third link 233) used for wireless LAN communication with the external electronic device 220. For example, the transmission power may be divided based on a service quality (e.g., a quality of service (QoS)) required for each link. For example, the transmission power may be equally divided for each link.

According to an embodiment, the processor 300 may identify reliability associated with wireless LAN communication of multiple links (e.g., the first link 231, the second link 232, and/or the third link 233) with the external electronic device 220. For example, the processor 300 may identify reliability associated with wireless LAN communication of each of the multiple links (e.g., the first link 231, the second link 232, and/or the third link 233) with the external electronic device 220. For example, the processor 300 may identify an average value of reliability associated with wireless LAN communication of the multiple links (e.g., the first link 231, the second link 232, and/or the third link 233) with the external electronic device 220.

For example, the processor 300 may identify the reliability of the wireless LAN communication of each link, based on information associated with a data transmission failure (or information associated with a data transmission success) of each link for a specified time period. For example, information associated with a data transmission failure may be included in state information of each of multiple links received by the processor 300 from the communication circuit 310. For example, the information associated with a data transmission failure may include at least one of a probability of a data transmission failure through each link or the number of data transmission failures. For example, the probability of a data transmission failure corresponds to a data retransmission rate and may be identified (or calculated) based on the number of data transmission failures for a designated time period. For example, the number of data transmission failures may include the number of data retransmissions during a designated time period. For example, the reliability associated with the wireless LAN communication may be calculated based on Equation 2.

$$Reliability = 1 - \frac{{TX}_{retransmission}}{{TotTX}_{count}} \qquad Equation 2$$

Here, Reliability may represent a reliability associated with wireless LAN communication, TXᵣₑₜᵣₐₙₛₘᵢₛₛᵢₒₙ may represent the number of data retransmission during a designated time period, and Tot TX_{count} may represent the number of data transmissions during a designated time period. For example, the number of data transmissions may include the number of data retransmissions.

According to an embodiment, the processor 300 may determine an operation mode for wireless LAN communication to be switched in case that there is a link that does not satisfy a designated reliability condition among multiple links (e.g., the first link 231, the second link 232, and/or the third link 233) with the external electronic device 220. According to an embodiment, the processor 300 may determine the operation mode for WLAN communication is to be maintained in a multi-mode in case that there is no link that does not satisfy a designated reliability condition among multiple links (e.g., the first link 231, the second link 232, and/or the third link 233) with the external electronic device 220. For example, the multi-mode may be an operation mode for performing wireless LAN communication through multiple links, and may include a multi-link multi-radio (MLMR). For example, a link satisfying the designated reliability condition may include a link having a reliability greater than or equal to a designated reliability. For example, a link that does not satisfy a designated reliability condition may include a link having a reliability less than the designated reliability. For example, the designated reliability may be independently configured for each link, based on at least one of the type of data to be transmitted and/or received in each link or the type of service. For example, the designated reliability may be configured commonly for multiple links, based on the type of service provided by the electronic device 101 through wireless LAN communication.

According to an embodiment, the processor 300 may determine the operation mode for wireless LAN communication to be switched in case that an average value of reliabilities of multiple links (e.g., the first link 231, the second link 232, and/or the third link 233) with the external electronic device 220 is determined to not satisfy a designated reliability condition. The processor 300 may determine the operation mode for WLAN communication is to be maintained in the multi-mode in case that an average value of the reliabilities of the multiple links (e.g., the first link 231, the second link 232, and/or the third link 233) with the external electronic device 220 satisfies the designated reliability condition. For example, a state of satisfying a designated reliability condition may include a state in which an average value of reliabilities of multiple links is equal to or greater than the designated reliability. For example, a state of not satisfying a designated reliability condition may include a state in which an average value of reliabilities of multiple links is less than the designated reliability.

According to an embodiment, in the case of determining the operation mode of the wireless LAN communication to be switched during wireless LAN communication through multiple links with the external electronic device 220, the processor 300 may control the communication circuit 310 to switch the operation mode of the wireless LAN communication from the multi-mode to a single mode. For example, in the case of determining the operation mode of the wireless LAN to be switched to the single mode, the processor 300 may select a link for performing the wireless LAN communication in the single mode from among multiple links (e.g., the first link 231, the second link 232, and/or the third link 233) with the external electronic device 220. For example, a link for performing wireless LAN communication in the single mode may be selected based on at least one of channel state information, a channel capacity, a maximum bandwidth, an available bandwidth, a channel congestion, a reliability, or a transmission rate of each of the multiple links. For instance, the channel state information may include at least one of a received signal strength indication (RSSI), a reference signal received quality (RSRQ), reference signal received power (RSRP), a signal to noise ratio (SNR), a signal to interference and noise ratio (SINR), a quality of service (QoS), or a bit error rate (BER). For example, the single mode may include a multi-link single radio (MLSR) or an enhanced MLSR (eMLSR). For example, a state of performing wireless LAN communication through multiple links (e.g., the multi-mode) may include multi-link multi-radio (MLMR).

For example, the processor 300 may control the communication circuit 310 to perform wireless LAN communication through a link selected to perform wireless LAN communication. For example, at least one of the multiple links, except for the link selected for performing wireless LAN communication, may be switched to be in a low power mode or may be deactivated (e.g., deactivate or off). For example, at least one remaining link may be switched to be in the low power mode through a traffic identifier (TID) to link mapping or power management.

For example, the transmission power of the electronic device 101 in the multi-mode may be similar to or the same as the transmission power of the electronic device 101 in the single mode. For example, the transmission power of the electronic device 101 in the multi-mode may include the sum of the transmission power of multiple links performing wireless LAN communication. For example, the transmission power of the electronic device 101 in the single mode may include the transmission power of a link performing wireless LAN communication.

According to an embodiment, the processor 300 may identify a utilization state of the transmission power of each of multiple links (e.g., the first link 231, the second link 232, and/or the third link 233 in FIG. 2) with the external electronic device (e.g., the external electronic device 220 in FIG. 2). For example, when performing wireless LAN communication with the external electronic device 220 through multiple links, the processor 300 may identify a utilization rate of transmission power allocated to each link. For example, in case of determining the operation mode for a wireless LAN communication to be switched, the processor 300 may identify a utilization rate of transmission power allocated to each link. For example, the transmission power utilization rate may indicate a ratio of the transmission power used by the electronic device 101 for data communication to the transmission power allocated to each link, based on the specific absorption rate (SAR). For example, the transmission power utilization rate may be calculated based on following Equation 3.

$${U}_{j} = \sum i \frac{{P}_{aggi}}{{P}_{lim} \times {T}_{win} \times k} \qquad Equation 3$$

Here, Uⱼ may represent the transmission power utilization rate of a j-th link, Pₗᵢₘ may represent a maximum transmission power allowed for wireless LAN communication based on a SAR, T_{win} may represent a time interval configured to calculate an average of transmission power in a TAS method, P_{aggi} may represent an accumulated value of transmission power used for wireless LAN communication before an i-th time point in T_{win}, and k may represent the number of scheduling slots required to change the transmission power of the link.

For example, in case that the transmission power utilization rate of the link is equal to or higher than a designated reference utilization rate, the processor 300 may determine that the transmission power utilization state of the link is a first state (e.g., fully utilized). In case that the transmission power utilization rate of the link is less than the designated reference utilization rate, the processor 300 may determine that the transmission power utilization state of the link is a second state (e.g., under-utilized) different from the first state. For example, the designated reference utilization rate may be a value (e.g., about 100%) designated to distinguish the utilization state of the transmission power of the link. For example, the designated reference utilization rate may be independently configured for each link, based on at least one of the type of data to be transmitted and/or received in each link or the type of service. For example, the designated reference utilization rate may be configured commonly for multiple links, based on the type of service provided by the electronic device 101 through wireless LAN communication.

According to an embodiment, the communication circuit 310 may support communication between the electronic device 101 and the external electronic device (e.g., the external electronic device 220 in FIG. 2). For example, the communication circuit 310 may include multiple communication circuits for performing wireless LAN communication through multiple links established with the external electronic device 220. For example, the multiple communication circuits may perform wireless LAN communication through different links (or frequency bands or at least partially different frequency bands). For example, the multiple communication circuits may be distinguished logically (e.g., by software). For example, the multiple communication circuits may be configured by different circuits or different hardware.

According to an embodiment, the memory 320 may store various data used by at least one component (e.g., the processor 300 or the communication circuit 310) of electronic device 101. For example, the memory 320 may store various instructions which may be executed individually or collectively through the processor 300.

According to an embodiment, an electronic device (e.g., the electronic device 101 in FIG. 1, 2, or 3) may include communication circuitry (e.g., the wireless communication module 192 in FIG. 1 or the communication circuit 310 in FIG. 3) configured to support wireless LAN communication, at least one processor (e.g., the processor 120 in FIG. 1 or the processor 300 in FIG. 3) including processing circuitry, and memory (e.g., the memory 130 in FIG. 1 or the memory 320 in FIG. 3) storing instructions. According to an embodiment, the instructions, when executed by the at least one processor individually or collectively, cause the electronic device to establish multiple links with an external electronic device (e.g., the external electronic device 220 in FIG. 2) through the communication circuitry. According to an embodiment, the instructions, when executed by the at least one processor individually or collectively, cause the electronic device to identify the reliability associated with the wireless LAN communication of each of the multiple links while performing wireless LAN communication through the multiple links. According to an embodiment, the instructions, when executed by the at least one processor individually or collectively, cause the electronic device to perform wireless LAN communication with an external electronic device through one of the multiple links, in case that at least one link which does not satisfy a designated reliability condition exists, based on the reliability associated with the wireless LAN communication of each of the multiple links.

According to an embodiment, the instructions, when executed by the at least one processor individually or collectively, cause the electronic device to identify a reliability associated with wireless LAN communication for each link, based on a data retransmission rate or the number of data retransmissions for each of the multiple links, for a designated time period.

According to an embodiment, the instructions, when executed by the at least one processor individually or collectively, cause the electronic device to perform wireless LAN communication with an external electronic device through one of the multiple links, in case that there is at least one link having a reliability related to wireless LAN communication smaller than a reference reliability.

According to an embodiment, the instructions, when executed by the at least one processor individually or collectively, cause the electronic device to select one link for performing wireless LAN communication from among the multiple links, in case that there is at least one link not satisfying a designated reliability condition, based on the reliability associated with the wireless LAN communication of each of the multiple links. According to an embodiment, the instructions, when executed by the at least one processor individually or collectively, cause the electronic device to perform wireless LAN communication with the external electronic device through a link selected for wireless LAN communication.

According to an embodiment, at least one of remaining links excluding the selected one of the multiple links may be switched to be in a low-power mode.

According to an embodiment, the instructions, when executed by the at least one processor individually or collectively, cause the electronic device to select one link based on at least one of a reception signal strength, a channel congestion, a reliability, or a transmission rate of each of the multiple links.

According to an embodiment, the instructions, when executed by the at least one processor individually or collectively, cause the electronic device to switch at least one remaining link, excluding a link selected for WLAN communication among the multiple links, to be in a low-power mode through a TID link mapping method or a power management method.

According to an embodiment, the instructions, when executed by the at least one processor individually or collectively, cause the electronic device to perform wireless LAN communication with an external electronic device through multiple links in case that there is no link not satisfying the designated reliability condition, based on the reliability associated with the wireless LAN communication of each of the multiple links.

According to an embodiment, the instructions, when executed by the at least one processor individually or collectively, cause the electronic device to identify a utilization state of transmission power allocated to each of the multiple links while performing wireless LAN communication through multiple links. According to an embodiment, the instructions, when executed by the at least one processor individually or collectively, cause the electronic device to reallocate transmission power of the multiple links in case that the utilization state of the transmission power allocated to the multiple links is different.

According to an embodiment, the transmission power utilization state may include a first state in which a utilization rate of transmission power allocated to the link is equal to or higher than a reference utilization rate, and a second state in which a utilization rate of transmission power allocated to the link is lower than the reference utilization rate.

According to an embodiment, the instructions, when executed by the at least one processor individually or collectively, cause the electronic device to reallocate surplus power of at least one link in the second state among the multiple links to at least one link in the first state among the multiple links.

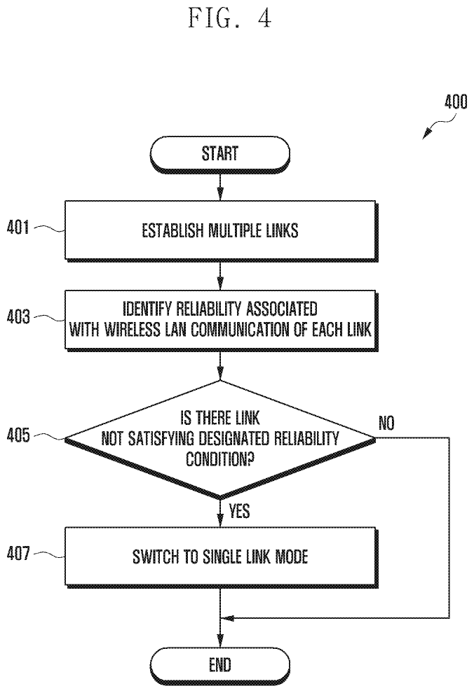

FIG. 4 is a flowchart 400 illustrating switching a wireless LAN communication operation mode, based on a reliability of each link, in an electronic device according to an embodiment of the disclosure.

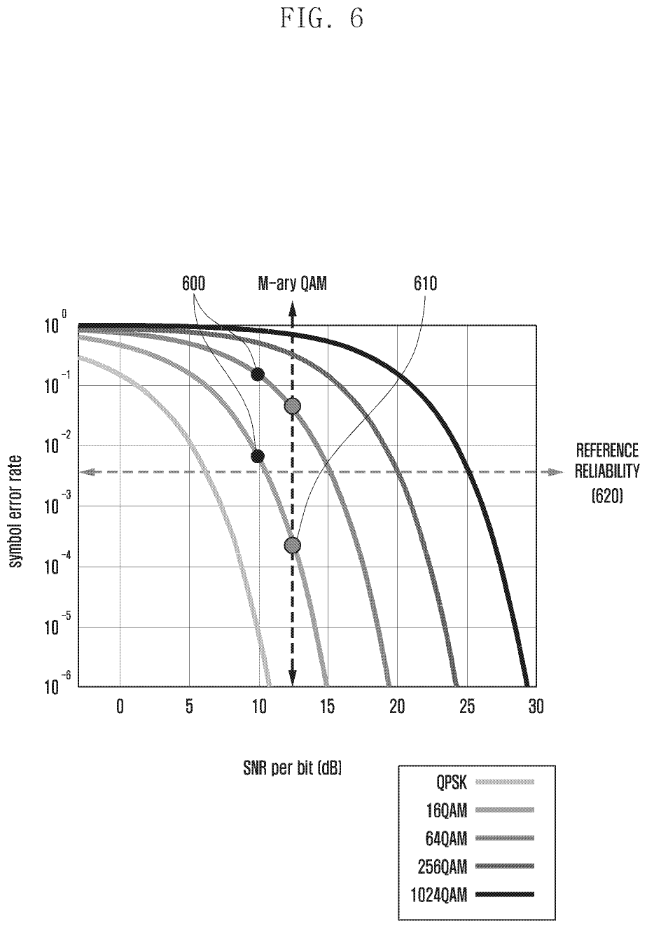

In the following embodiment, respective operations may be sequentially performed, but are not necessarily sequentially performed. For example, the sequential position of each operation may be changed, or at least two operations may be performed in parallel. For example, the electronic device in FIG. 4 may correspond to the electronic device 101 in FIG. 1, 2, or 3. For example, at least a portion of FIG. 4 will be described with reference to FIG. 6.

FIG. 6 is an example of a reliability based on a wireless LAN communication operation mode in an electronic device according to an embodiment of the disclosure.

Referring to FIGS. 4 and 6, an electronic device (e.g., the electronic device 101 in FIG. 1, 2, or 3) or a processor (e.g., the processor 120 in FIG. 1 or the processor 300 in FIG. 3) may establish multiple links (e.g., the first link 231, the second link 232, and/or the third link 233 in FIG. 2) with an external electronic device (e.g., the external electronic device 220 in FIG. 2) in operation 401. For example, the processor 300 may control the communication circuit 310 to establish multiple links with the external electronic device 220 through at least one link among multiple frequency bands supported by the electronic device 101. For example, the processor 300 may acquire information related to MLO of the external electronic device 220 from a beacon or a probe response frame received through at least one frequency band (e.g., the first frequency band (or the first link 231)) from the external electronic device 220. The processor 300 may control the communication circuit 310 to transmit an association request frame associated with the multiple links to the external electronic device 220 through at least one link, based on information associated with MLO of the external electronic device 220. For example, in case that information associated with an acceptance is acquired from the external electronic device 220 in response to the association request frame, the processor 300 may determine that multiple links with the external electronic device 220 have been established. For example, in case that information associated with a rejection related to at least one of the multiple links is acquired from the external electronic device 220 in response to the association request frame, the processor 300 may determine that the establishment of at least one link with the external electronic device 220, which corresponds to the rejection-related information among the multiple links, has failed. For example, the at least one link corresponding to the rejection-related information may be excluded from a link establishment with the external electronic device 220. By way of example, the association request frame corresponds to information related to the establishment of the first link 231, the second link 232, and/or the third link 233, and may include information related to the function (capability) and/or operational parameter of each link. For example, the information associated with MLO may include not only information associated with the first frequency band (or the first link 231) through which a beacon or a probe response frame has been received, but also information associated with the second frequency band (or the second link 232) and/or the third frequency band (or the third link 233) which are supportable by the external electronic device 220 for MLO. For example, information associated with a frequency band (or link) may include a basic service set identifier (BSSID) and/or a variable associated with MLO for each frequency band (or link).

According to an embodiment, the electronic device (e.g., the electronic device 101) or the processor (e.g., the processor 120 or 300) may, in operation 403, identify reliability associated with wireless LAN communication of each of the multiple links with the external electronic device. For example, the processor 300 may identify the reliability of wireless LAN communication of each link, based on information associated with a data transmission failure (or information associated with a data transmission success) of each of multiple links used for wireless LAN communication with the external electronic device 220 for a designated time period. For example, information associated with a data transmission failure may be included in state information of each of multiple links received by the processor 300 from the communication circuit 310. For example, the information associated with a data transmission failure may include at least one of a probability of a data transmission failure through each link or the number of data transmission failures. For example, the probability of a data transmission failure corresponds to a data retransmission rate and may be identified (or calculated) based on the number of data transmission failures for a designated time period. For example, the number of data transmission failures may include the number of data retransmissions during a designated time period.

According to an embodiment, the electronic device (e.g., the electronic device 101) or the processor (e.g., the processor 120 or 300) may, in operation 405, identify whether there is a link not satisfying a designated reliability condition among multiple links (e.g., the first link 231, the second link 232, and/or the third link 233) with external electronic devices. For example, a link that does not satisfy a designated reliability condition may include a link having a reliability less than or equal to the designated reliability. For example, a link satisfying the designated reliability condition may include a link having a reliability greater than or equal to a designated reliability. For example, the designated reliability may be independently configured for each link, based on at least one of the type of data to be transmitted and/or received in each link or the type of service. For example, the designated reliability may be configured commonly for multiple links, based on the type of service provided by the electronic device 101 through wireless LAN communication.

According to an embodiment, in case that there is no link that does not satisfy the designated reliability condition among the multiple links with the external electronic device (e.g., “No” in operation 405), the electronic device (e.g., electronic device 101) or the processor (e.g., processor 120 or 300) may terminate an embodiment for switching the operation mode of the wireless LAN communication. For example, the processor 300 may determine that links used for wireless LAN communication with an external electronic device satisfy the reliability required for wireless LAN communication, in case that there is no link that does not satisfy the designated reliability condition among the multiple links with the external electronic device. The processor 300 may control the communication circuit 310 to perform wireless LAN communication with the external electronic device through multiple links.

According to an embodiment, in case that there is a link that does not satisfy the designated reliability condition among the multiple links with the external electronic device (e.g., “Yes” in operation 405), the electronic device (e.g., electronic device 101) or the processor (e.g., processor 120 or 300) may, in operation 407, switch the operation mode of wireless LAN communication from a multi-mode to a single mode. For example, the processor 300 may determine the operation mode of wireless LAN communication to be switched to the single mode in case that there is no link that does not satisfy the designated reliability condition among the multiple links with the external electronic device 220. For example, the processor 300 may, in case that the reliability 600 of the first link 231 and the second link 232 using 16QAM (quadrature amplitude modulation) and 64QAM is lower than the designated reference reliability 620, determine that the reliability required for wireless LAN communication may not be satisfied. The processor 300 may determine the operation mode of the wireless LAN communication to be switched to the single mode, based on the determination that the reliability required for the wireless LAN communication may not be satisfied through the multiple links.

For example, in the case of determining to switch the operation mode of the wireless LAN to the single mode, the processor 300 may select a link for performing the wireless LAN communication in the single mode from among multiple links (e.g., the first link 231, the second link 232, and/or the third link 233) with the external electronic device 220. For example, a link for performing wireless LAN communication in the single mode may be selected based on at least one of channel state information, a channel capacity, a maximum bandwidth, an available bandwidth, a channel congestion, a reliability, or a transmission rate of each of the multiple links. For instance, the channel state information may include at least one of a received signal strength indication (RSSI), a reference signal received quality (RSRQ), reference signal received power (RSRP), a signal to noise ratio (SNR), a signal to interference and noise ratio (SINR), a quality of service (QoS), or a bit error rate (BER). For example, the processor 300 may control the communication circuit 310 to perform wireless LAN communication through a link selected to perform wireless LAN communication. For example, the processor 300 may control the communication circuit 310 so that at least one remaining link, excluding the link selected to perform WLAN communication in the single mode, among the multiple links is switched to the low-power mode or deactivated (e.g., deactivate or off) through TID link mapping (e.g., TID to link mapping) or power management. For example, the switching to the low-power mode may include a series of operations of removing a traffic identifier (TID) allocated to a corresponding link. For example, the switching to the low-power mode may include a series of operations of configuring a power management (PM) bit of a “null data frame” to a first value (e.g., “1”) and transmitting same to the external electronic device 220 through the corresponding link.

According to an embodiment, when performing wireless LAN communication in the single mode, the processor 300 may increase a signal quality (e.g., SNR) without changing a modulation and coding scheme (MCS) level of the link by using the transmission power, which has been divided into multiple links, in one link. The reliability 610 of the link performing wireless LAN communication in the single mode may be improved to be higher than the reference reliability 620 designated based on the improvement of the signal quality of the corresponding link.

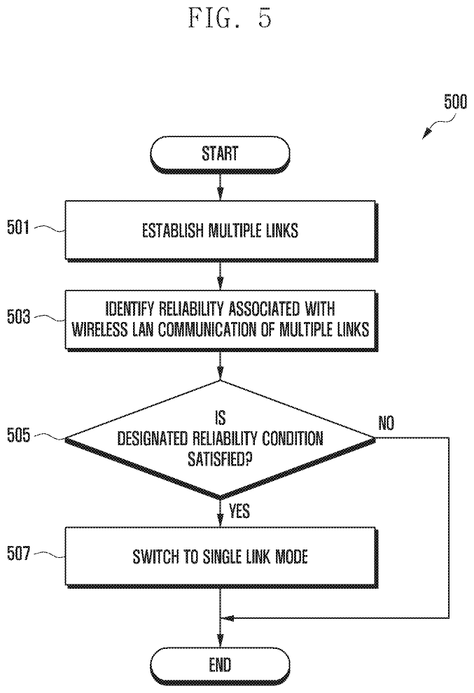

FIG. 5 is a flowchart 500 illustrating switching a wireless LAN communication operation mode, based on a reliability of multiple links, in an electronic device according to an embodiment of the disclosure.

In the following embodiment, respective operations may be sequentially performed, but are not necessarily sequentially performed. For example, the sequential position of each operation may be changed, or at least two operations may be performed in parallel. For example, the electronic device in FIG. 5 may correspond to the electronic device 101 in FIG. 1, 2, or 3.

According to an embodiment referring to FIG. 5, an electronic device (e.g., the electronic device 101 in FIG. 1, 2, or 3) or a processor (e.g., the processor 120 in FIG. 1 or the processor 300 in FIG. 3) may establish multiple links (e.g., the first link 231, the second link 232, and/or the third link 233 in FIG. 2) with an external electronic device (e.g., the external electronic device 220 in FIG. 2) in operation 501. For example, the processor 300 may control the communication circuit 310 to establish multiple links with the external electronic device 220 through at least one link among multiple frequency bands supported by the electronic device 101. For example, the processor 300 may control the communication circuit 310 to establish multiple links for wireless LAN communication through negotiation with the external electronic device 220.

According to an embodiment, the electronic device (e.g., the electronic device 101) or the processor (e.g., the processor 120 or 300) may, in operation 503, identify reliability associated with wireless LAN communication of the multiple links with the external electronic device. For example, the processor 300 may identify the reliability of wireless LAN communication of each link, based on information associated with a data transmission failure (or information associated with a data transmission success) of each of multiple links used for wireless LAN communication with the external electronic device 220 for a designated time period. The processor 300 may identify an average value of reliabilities of the multiple links used for the wireless LAN communication with the external electronic device 220, based on the reliability associated with the wireless LAN communication of each link. For example, information associated with a data transmission failure may be included in state information of each of multiple links received by the processor 300 from the communication circuit 310. For example, the information associated with a data transmission failure may include at least one of a probability of a data transmission failure through each link or the number of data transmission failures. For example, the probability of a data transmission failure corresponds to a data retransmission rate and may be identified (or calculated) based on the number of data transmission failures for a designated time period. For example, the number of data transmission failures may include the number of data retransmissions during a designated time period.

According to an embodiment, the electronic device (e.g., the electronic device 101) or the processor (e.g., the processor 120 or 300) may, in operation 505, whether a designated reliability condition is satisfied, based on the reliability associated with the wireless LAN communication of the multiple links with the external electronic device. For example, the processor 300 may determine that the designated reliability condition is not satisfied in case that the average value of the reliabilities of the multiple links (e.g., the first link 231, the second link 232, and/or the third link 233) for wireless LAN communication with the external electronic device 220 is lower than the designated reliability. For example, the processor 300 may determine that the designated reliability condition is satisfied in case that the average value of the reliabilities of the multiple links (e.g., the first link 231, the second link 232, and/or the third link 233) for wireless LAN communication with the external electronic device 220 is equal to or greater than the designated reliability. For example, the designated reliability may be configured commonly for multiple links, based on the type of service provided by the electronic device 101 through wireless LAN communication.

According to an embodiment, in the case of determining that the designated reliability condition is satisfied (e.g., “Yes” in operation 505), the electronic device (e.g., electronic device 101) or the processor (e.g., processor 120 or 300) may terminate an embodiment for switching the operation mode of the wireless LAN communication. For example, in the case of determining that the average value of the reliabilities of multiple links with the external electronic device satisfies the designated reliability condition, the processor 300 may determine that the links used for wireless LAN communication with the external electronic device satisfy the reliability required for the wireless LAN communication. The processor 300 may control the communication circuit 310 to perform wireless LAN communication with the external electronic device through multiple links.

According to an embodiment, in the case of determining that the designated reliability condition is not satisfied (e.g., “No” in operation 505), the electronic device (e.g., electronic device 101) or the processor (e.g., processor 120 or 300) may, in operation 507, switch the operation mode of wireless LAN communication from the multi-mode to the single mode. For example, in the case of determining that the designated reliability condition is not satisfied, based on the average value of the reliabilities of multiple links with the external electronic device 220, the processor 300 may determine that the reliability required for wireless LAN communication may not be satisfied. The processor 300 may determine the operation mode of the wireless LAN communication to be switched to the single mode, based on the determination that the reliability required for the wireless LAN communication may not be satisfied through the multiple links.

For example, in the case of determining to switch the operation mode of the wireless LAN to the single mode, the processor 300 may select a link for performing the wireless LAN communication in the single mode from among multiple links (e.g., the first link 231, the second link 232, and/or the third link 233) with the external electronic device 220. For example, a link for performing wireless LAN communication in the single mode may be selected based on at least one of channel state information, a channel capacity, a maximum bandwidth, an available bandwidth, a channel congestion, a reliability, or a transmission rate of each of the multiple links. For example, the channel state information may include at least one of RSSI, a RSRQ, RSRP, a SNR, a SINR, a QoS, or a BER. For example, the processor 300 may control the communication circuit 310 to perform wireless LAN communication through a link selected to perform wireless LAN communication. For example, the processor 300 may control the communication circuit 310 so that at least one remaining link, excluding the link selected to perform WLAN communication in the single mode, among the multiple links is switched to the low-power mode through TID link mapping or power management.

According to an embodiment, when performing wireless LAN communication in the single mode, the processor 300 may increase a signal quality (e.g., SNR) without changing an MCS level of the link by using the transmission power, which has been divided into multiple links, in one link. The reliability 610 of the link performing wireless LAN communication in the single mode may be improved to be higher than the reference reliability 620 designated based on the improvement of the signal quality of the corresponding link.

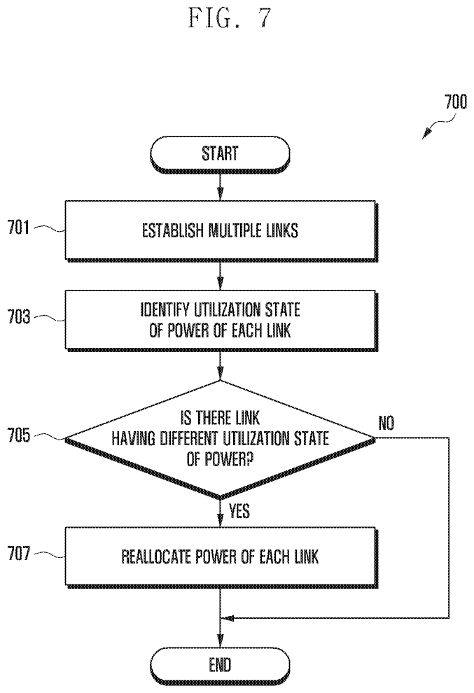

FIG. 7 is a flowchart 700 illustrating reallocating transmission power of multiple links in an electronic device according to an embodiment of the disclosure.

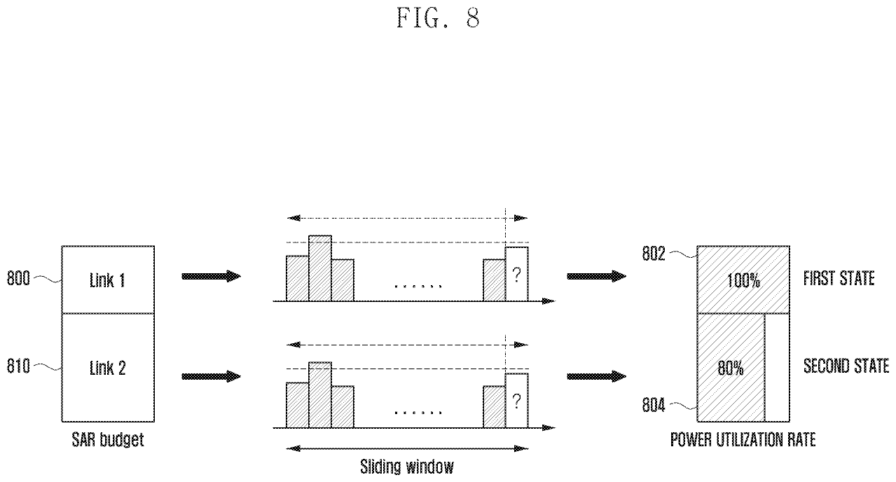

In the following embodiment, respective operations may be sequentially performed, but are not necessarily sequentially performed. For example, the sequential position of each operation may be changed, or at least two operations may be performed in parallel. For example, the electronic device in FIG. 7 may correspond to the electronic device 101 in FIG. 1, 2, or 3. For example, at least a portion of FIG. 7 will be described with reference to FIG. 8.

FIG. 8 is an example of reallocating transmission power of multiple links in an electronic device according to an embodiment of the disclosure.

Referring to FIGS. 7 and 8, an electronic device (e.g., the electronic device 101 in FIG. 1, 2, or 3) or a processor (e.g., the processor 120 in FIG. 1 or the processor 300 in FIG. 3) may establish (set up) multiple links (e.g., the first link 231, the second link 232, and/or the third link 233 in FIG. 2) with an external electronic device (e.g., the external electronic device 220 in FIG. 2) in operation 701. For example, the processor 300 may control the communication circuit 310 to establish multiple links with the external electronic device 220 through at least one link among multiple frequency bands supported by the electronic device 101. For example, the processor 300 may control the communication circuit 310 to establish multiple links for wireless LAN communication through negotiation with the external electronic device 220.

According to an embodiment, the electronic device (e.g., the electronic device 101) or the processor (e.g., the processor 120 or 300) may, in operation 703, identify a utilization state of transmission power allocated to each of the multiple links with the external electronic device. For example, when performing wireless LAN communication with the external electronic device 220 through multiple links, the processor 300 may identify a utilization rate of transmission power allocated to each link. For example, the transmission power utilization rate may indicate a ratio of the transmission power used by the electronic device 101 for data communication to the transmission power allocated to each link, based on the specific absorption rate (SAR).

For example, in case that the transmission power utilization rate of the link is equal to or higher than a designated reference utilization rate, the processor 300 may determine that the transmission power utilization state of the link is a first state (e.g., fully utilized). In case that the transmission power utilization rate of the link is less than the designated reference utilization rate, the processor 300 may determine that the transmission power utilization state of the link is a second state (e.g., under-utilized) different from the first state. For example, the designated reference utilization rate may be a value (e.g., about 100%) designated to distinguish the utilization state of the transmission power of the link. For example, the designated reference utilization rate may be independently configured for each link, based on at least one of the type of data to be transmitted and/or received in each link or the type of service. For example, the designated reference utilization rate may be configured commonly for multiple links, based on the type of service provided by the electronic device 101 through wireless LAN communication.

According to an embodiment, the electronic device (e.g., the electronic device 101) or the processor (e.g., the processor 120 or 300) may, in operation 705, identify whether a link having a different utilization state of transmission power exists among the multiple links with the external electronic device.

According to an embodiment, in case that there is no link having a different utilization state of transmission power among multiple links with the external electronic device (e.g., “No” in operation 705), the electronic device (e.g., electronic device 101) or the processor (e.g., processor 120 or 300) may terminate an embodiment for reallocating the transmission power of the multiple links. For example, in case that the utilization states of the transmission powers of multiple links used for the wireless LAN communication with the external electronic device 220 are the same as the first state (or the second state), the processor 300 may control the communication circuit 310 such that the transmission power allocated to each link is maintained.

According to an embodiment, in case that there is a link having a different utilization state of transmission power among multiple links with the external electronic device (e.g., “Yes” in operation 705), the electronic device (e.g., electronic device 101) or the processor (e.g., processor 120 or 300) may, in operation 707, reallocate the transmission power allocated to links having a different utilization state of transmission power. For example, the processor 300 may identify the utilization state of the transmission power of the first link 231 and the second link 232 when using the first link 231 and the second link 232 for the WLAN communication with the external electronic device 220. In case that the utilization state of the transmission power of the first link 231 or 800 is a first state 802 and the utilization state of the transmission power of the second link 232 or 810 is a second state 804, the processor 300 may determine that the transmission power allocated to the first link 231 and the second link 232 is to be reallocated. The processor 300 may additionally allocate a portion of the transmission power allocated to the second link 232 in the second state to the first link 231 in the first state. For example, the first link 231 may perform, based on the specific absorption rate (SAR), wireless LAN communication, based on transmission power allocated to the first link 231 and transmission power reallocated from the second link 232. For example, the portion of the transmission power allocated to the second link 232 may include transmission power having an amount determined not to be used for data communication in the second link 232 among the transmission power allocated to the second link 232, based on the specific absorption rate (SAR).

According to an embodiment, in the case of determining to switch the operation mode for the wireless LAN communication to the single mode, based on the reliability of the multiple links with the external electronic device 220, the electronic device 101 may reallocate the transmission power to each link, based on the utilization state of the transmission power of each of the multiple links.

According to an embodiment, an operation method for an electronic device (e.g., the electronic device 101 in FIG. 1, 2, or 3) may include an operation of establishing multiple links for wireless LAN communication with an external electronic device (e.g., the external electronic device 220 in FIG. 2). According to an embodiment, the operation method for the electronic device may include an operation of identifying the reliability associated with the wireless LAN communication of each of the multiple links while performing wireless LAN communication through multiple links. According to an embodiment, the operation method for the electronic device may include an operation of performing wireless LAN communication with an external electronic device through one of the multiple links, in case that at least one link which does not satisfy a designated reliability condition exists, based on the reliability associated with the wireless LAN communication of each of the multiple links.

According to an embodiment, the operation of identifying the reliability may include an operation of identifying the reliability associated with the wireless LAN communication of each of the multiple links, based on the data retransmission rate or the number of data retransmissions of each of the multiple links, for a designated time period.

According to an embodiment, the operation of performing WLAN communication may include, in case that there is at least one link having a reliability associated with WLAN communication smaller than a designated reference reliability among multiple links, an operation of performing WLAN communication with the external electronic device through one of the multiple links.

According to an embodiment, the operation of performing wireless LAN communication may include, in case that there is at least one link not satisfying a designated reliability condition, based on the reliability associated with the wireless LAN communication of each of the multiple links, an operation of selecting one link for performing wireless LAN communication from among the multiple links. According to an embodiment, the operation method for the electronic device may include an operation of performing wireless LAN communication with the external electronic device through a link selected for wireless LAN communication.

According to an embodiment, at least one of remaining links excluding the link selected for wireless LAN communication from among the multiple links may be switched to be in a low-power mode.

According to an embodiment, the operation of selecting a link may include an operation of selecting a link, based on at least one of a reception signal strength, a channel congestion, a reliability, or a transmission rate of each of the multiple links.

According to an embodiment, the operation method for the electronic device may include, in case that there is no link which does not satisfy the designated reliability condition, based on the reliability associated with the wireless LAN communication of each of the multiple links, an operation of performing wireless LAN communication with the external electronic device through the multiple links.

According to an embodiment, the operation method for the electronic device may include an operation of identifying a utilization state of transmission power allocated to each of the multiple links while performing wireless LAN communication through multiple links. According to an embodiment, the operation method for the electronic device may include an operation of reallocating the transmission power of the multiple links in case that utilization states of the transmission power allocated to the multiple links are different.

According to an embodiment, the transmission power utilization state may include a first state in which a utilization rate of transmission power allocated to the link is equal to or higher than a reference utilization rate, and a second state in which a utilization rate of transmission power allocated to the link is lower than the reference utilization rate.

According to an embodiment, the operation of reallocating may include an operation of reallocating surplus power of at least one link in a second state among multiple links to at least one link in a first state among the multiple links.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. An electronic device comprising:
communication circuitry configured to send and receive a signal via wireless local area network (LAN) communication;
memory, comprising one or more storage media, storing instructions; and
one or more processors communicatively coupled to the communication circuit and the memory,
wherein the instructions, when executed by the one or more processors individually or collectively, cause the electronic device to:
establish multiple links with an external electronic device through the communication circuitry,
identify a wireless LAN communication-related reliability of each of the multiple links while performing wireless LAN communication through the multiple links, and
when at least one link of the multiple links does not satisfy a designated reliability condition, based on the wireless LAN communication-related reliability of each of the multiple links, perform wireless LAN communication with the external electronic device through another link of the multiple links.

2. The electronic device of claim 1, wherein the instructions, when executed by the one or more processors individually or collectively, cause the electronic device to, based on a data retransmission rate or a number of times of data retransmissions via each of the multiple links for a designated time period, identify the wireless LAN communication-related reliability of each of the multiple links.

3. The electronic device of claim 1, wherein the at least one link not satisfying the designated reliability condition has a wireless LAN communication-related reliability smaller than a reference reliability.

4. The electronic device of claim 1,
wherein the instructions, when executed by the one or more processors individually or collectively, cause the electronic device to:
when the at least one link of the multiple links does not satisfy the designated reliability condition, based on the wireless LAN communication-related reliability of each of the multiple links, select the another link for performing wireless LAN communication from among the multiple links, and
perform wireless LAN communication with the external electronic device through the selected another link, and
wherein at least one link other than the selected another link among the multiple links is switched to a low-power mode.

5. The electronic device of claim 4, wherein the instructions, when executed by the one or more processors individually or collectively, cause the electronic device to select the another link, based on at least one of a received signal strength, a channel congestion, a reliability, or a transmission rate of each of the multiple links.

6. The electronic device of claim 4, wherein the instructions, when executed by the one or more processors individually or collectively, cause the electronic device to switch the at least one link other than the selected another link among the multiple links to the low-power mode through a traffic identifier (TID) link mapping scheme or a power management scheme.

7. The electronic device of claim 1, wherein the instructions, when executed by the one or more processors individually or collectively, cause the electronic device to:
identify a utilization state of transmission power allocated to each of the multiple links while performing wireless LAN communication through the multiple links; and
when the utilization state of transmission power allocated to each of the multiple links are different, reallocate transmission power of the multiple links.

8. The electronic device of claim 7, wherein the utilization state of transmission power comprises:
a first state in which the utilization rate of transmission power allocated to a link is equal to or greater than a reference utilization rate, or
a second state in which the utilization rate of transmission power allocated to a link is less than the reference utilization rate.

9. The electronic device of claim 8, wherein the instructions, when executed by the one or more processors individually or collectively, cause the electronic device to reallocate surplus power of at least one link in the second state among the multiple links to at least one link in the first state among the multiple links.

10. A method performed by an electronic device, the method comprising:
establishing, by the electronic device, multiple links for wireless local area network (LAN) communication with an external electronic device;
identifying, by the electronic device, a wireless LAN communication-related reliability of each of the multiple links while performing wireless LAN communications through the multiple links; and
when at least one link of the multiple links does not satisfy a designated reliability condition, based on the wireless LAN communication-related reliability of each of the multiple links, performing, by the electronic device, wireless LAN communication with the external electronic device through another link of the multiple links.

11. The method of claim 10, wherein the identifying of the reliability comprises, based on a data retransmission rate or a number of times via data retransmissions of each of the multiple links for a designated time period, identifying the wireless LAN communication-related reliability of each of the multiple links.

12. The method of claim 10, wherein the at least one link not satisfying the designated reliability condition has a wireless LAN communication-related reliability smaller than a designated reference reliability.

13. The method of claim 12, wherein the performing of wireless LAN communication comprises:
when the at least one link of het multiple links does not satisfy the designated reliability condition, based on the wireless LAN communication-related reliability of each of the multiple links, selecting another link for performing wireless LAN communication from among the multiple links; and
performing wireless LAN communication with the external electronic device through the selected another link.

14. The method of claim 13, further comprising:
switching, by the electronic device, at least one link other than the selected another link among the multiple links to a low-power mode through a traffic identifier (TID) link mapping scheme or a power management scheme.

15. The method of claim 13, wherein the selecting of the another link comprises selecting the another link, based on at least one of a received signal strength, a channel congestion, a reliability, or a transmission rate of each of the multiple links.

16. The method of claim 10, further comprising:
identifying a utilization state of transmission power allocated to each of the multiple links while performing wireless LAN communication through the multiple links; and
when the utilization state of transmission power allocated to each of the multiple links are different, reallocating transmission power of the multiple links.

17. The method of claim 16, wherein the utilization state of transmission power comprises:
a first state in which the utilization rate of transmission power allocated to a link is equal to or greater than a reference utilization rate, or
a second state in which the utilization rate of transmission power allocated to a link is less than the reference utilization rate.

18. The method of claim 17, further comprising:
reallocating surplus power of at least one link in the second state among the multiple links to at least one link in the first state among the multiple links.

19. One or more non-transitory computer-readable storage media storing one or more computer programs including computer-executable instructions that, when executed by one or more processors of an electronic device individually or collectively, cause the electronic device to perform operations, the operations comprising:
establishing, by the electronic device, multiple links for wireless local area network (LAN) communication with an external electronic device;
identifying, by the electronic device a wireless LAN communication-related reliability of each of the multiple links while performing wireless LAN communications through the multiple links; and
when at least one link of the multiple links does not satisfy a designated reliability condition, based on the wireless LAN communication-related reliability of each of the multiple links, performing, by the electronic device, wireless LAN communication with the external electronic device through another link of the multiple links.

20. The one or more non-transitory computer-readable storage media of claim 19,
wherein the at least one link not satisfying the designated reliability condition has a wireless LAN communication-related reliability smaller than a designated reference reliability, and
wherein the performing of wireless LAN communication comprises:
when the at least one link of het multiple links does not satisfy the designated reliability condition, based on the wireless LAN communication-related reliability of each of the multiple links, selecting another link for performing wireless LAN communication from among the multiple links, and
performing wireless LAN communication with the external electronic device through the selected another link.
